(19) United States
(12) Patent Application Publication
(10) Pub. No.: US 2012/0185404 A1
(43) Pub. Date: Jul. 19, 2012

(54) Global and Local Shipping Charge System in Online Marketplace or Auction Portal

(76) Inventor: Kwon Suk Koh, Seoul (KR)

(21) Appl. No.: 13/350,759

(22) Filed: Jan. 14, 2012

(30) Foreign Application Priority Data
Jan. 14, 2011 (KR) 10-2011-0004211

(51) Int. Cl. G06Q 30/00

(52) U.S. Cl. 705/335

(57) ABSTRACT

A global and local shipping charge system enables a seller entity or an administrator of an online marketplace to redefine customized shipping charge rates by its own customized geographic zoning. For example, the global and local shipping charge system can take some shipping charge-related information from one or more carriers, and allow the seller entity or the online marketplace to re-define or customize shipping charges based on a preferred domestic and international geographic zoning by the seller entity or the online marketplace. The redefinition of shipping charges based on the seller entity's or the online marketplace's specific circumstances may offer more cost-efficient and accurate shipping charges to customers. Examples of specific circumstances resulting in more cost-efficiency and shipping charge accuracy include the seller entity's special discount structure per customized geographic shipping zone with several carriers, and the proximity of the seller entity's shipping origination center to recipient addresses.

### BACKGROUND OF THE INVENTION

The present invention generally relates to electronic commerce systems and infrastructure. More specifically, the present invention relates to a global and local shipping charge system in an online marketplace and/or an online auction portal. In particular, various embodiments of the present invention relate to deriving accurate shipping costs based on customized zoning of nations, states, and municipalities by an online marketplace or online auction administrator or a seller entity, which is a registered member of the online marketplace.

Numerous computer network-based (i.e. Internet-based) online marketplaces or online auction portals offer seller entities (e.g. shops, brokers, distributors, wholesalers, individuals, and etc.) a convenient method to register with a particular online marketplace or an online auction portal to enable the seller entities' to offer items or products for sale to consumers or businesses. An example of a popular online marketplace is “Amazon Marketplace,” which utilizes its brand value and heavy website traffic to lure numerous seller entities to offer their products through Amazon's online e-commerce infrastructure and user interfaces. Similarly, “eBay” is an example of a popular online auction portal which lures numerous seller entities to offer their products through eBay's online auction and e-commerce infrastructure and user interfaces.

In general, online marketplaces or online auction portals provide ballpark-estimate-based shipping charges or flat-rate shipping charges prior to completion of a transaction for a product/item purchase by a buyer. In some cases, the shipping charge may be complimentary for a product and/or an item above a certain purchase price, especially if the shipping can be completed domestically. In other cases, the shipping charge estimate given at the time of transaction for the buyer is above or below the actual cost of shipping requested by a carrier or a shipping company, because most online marketplaces or auction portals are unable to provide accurate and real-time changes in shipping costs offered by a variety of carriers.

Buyers, selling entities, or administrators to an online marketplace or an auction portal, which accommodates and brokers the selling entities and the buyers, often have to bear the burden of cost differentials between an actual cost of shipping vs. a presumptive cost of shipping charged to a particular buyer. For example, if the presumptive cost of shipping is above the actual cost of shipping charged by a carrier, a buyer is paying more than an exact amount for the cost of shipping for additional profits by a selling entity, an online market place/auction portal, or the carrier. On the other hand, if the presumptive cost of shipping is less than the actual cost of shipping (i.e. which may change dynamically based on zones and fuel costs, for example) charged by the carrier, the selling entity or the online marketplace/auction portal may have to absorb the cost differential, which results in margin compression. In many situations, it is a customary business practice to overcharge a buyer for the cost of shipping presumptively, so that the selling entity or the online marketplace/auction portal has sufficient reserves per a shipped product/item in case that an actual cost of shipping runs over an internal estimate by the selling entity or the online marketplace/auction portal. In some other situations (e.g. in international shipments), the selling entity or the online marketplace/auction portal only gives a shipping estimate to a buyer, and an actual shipping cost is charged subsequently after the shipment of a product/item, which places the buyer at an unfair disadvantage of not knowing the exact amount he or she has to pay for shipping.

The discrepancy between a presumptively-charged cost of shipping to a buyer vs. an actual cost of shipping incurred by a carrier may be particularly significant in international shipments, which generally garner higher shipping charges. A buyer may benefit from availability of accurate and potentially dynamically-changing shipping costs from an online marketplace or an auction portal, which can uniquely take the proximity of the shipment origin address and the recipient's address into account on a real-time basis. Furthermore, a selling entity, an online marketplace, or an auction portal may also benefit by providing a customized, real-time, and dynamically-changing shipping cost by utilizing a zone-based global and local shipping charge system.

Therefore, it may be desirable to devise a zone-based global and local shipping charge system which allows a seller entity, an online marketplace, and/or an auction portal to categorize and customize geographic zones both globally and locally for flexible, real-time, and dynamic shipping charge rate offerings to buyers. Furthermore, it may be also desirable to devise a zone-based global and local shipping charge system, which communicates information with shipping logistics systems from numerous carriers, but can be customized by a seller entity, an online marketplace, and/or an auction portal for more flexible pricing structures based on customized geographic zoning by nationalities, states, and/or municipalities relative to an origin address and recipient addresses.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a method of generating customized shipping zones and shipping charges using a global and local shipping zone customizer and shipping charge system is disclosed. This method comprises the steps of: creating shipping zone definitions with a computer user interface for nation zones, state zones, and city zones, wherein the created shipping zone definitions are independent of a shipping company's standard shipping rates, and wherein the created shipping zone definitions are defined by a seller entity's or an online marketplace's region-specific business circumstances and region-specific relationships domestically and internationally; placing nations, states, municipalities, and/or other points of interest into the nation zones, the state zones, the city zones, and/or other point of interest zones by using the computer user interface, wherein the computer user interface is associated with one or more program modules executed on a memory unit and a CPU of a computer system operating the global and local shipping zone customizer and shipping charge system; associating the nation zones, the state zones, the city zones, and/or the other point of interest zones with shipping charge rates to produce a zone-based customized shipping charge template, wherein the shipping charge rates are either manually entered by the seller entity or modified from existing information; categorizing a recipient's address entered by the buyer into a destination shipping zone characterized by at least one of the nation zones, the state zones, the city zones, and/or the other point of interest zones; and generating a zone-based shipping charge for a particular item to be purchased by a buyer using the zone-based customized shipping charge template, the recipient's address entered by the buyer, and a shipping origination address.

### BRIEF DESCRIPTION OF DRAWINGS

FIG. 1 shows a concept of grouping and/or zoning nations for global shipping calculations using a global and local shipping charge system, in accordance with an embodiment of the invention.

FIG. 2 shows an example of a customized geographic zoning for shipping origin addresses and/or recipient addresses by using a global and local shipping charge system, in accordance with an embodiment of the invention.

FIG. 3 shows another example of a customized geographic zoning for shipping origin addresses and/or recipient addresses by using a global and local shipping charge system, in accordance with an embodiment of the invention.

FIG. 4 shows a method for deriving the shipping cost based on a customizable geographic zoning plan, in accordance with an embodiment of the invention.

FIG. 5 shows a first pull-down menu interface for defining a nation zone, a second pull-down menu interface for defining a state zone, and a shipping charge plan customization interface for international “nations zones” and national “region zones” for usage by a seller entity or an online marketplace/auction portal administrator, in accordance with an embodiment of the invention.

FIG. 6 shows a screenshot of a seller entity's shipping charge plan customization interface for an interne marketplace/shopping portal, in accordance with an embodiment of the invention.

FIG. 7 shows an interaction diagram among a buyer, an online marketplace/auction administrator, a seller entity, and a shipping zone customizer and shipping charge system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble a global and local shipping charge system for an online marketplace, an auction portal, and/or an online shopping mall. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

For the purpose of describing the invention, a term “zone” is defined as a region characterized by national, state, city, or another defined boundary for categorizing and deriving shipping charges. For example, if a shipping origin address and a recipient address is in the same city “zone,” the associated shipping charge may be much cheaper than another recipient address in a different city zone. In another example, a foreign province (e.g. Ontario in Canada) geographically close to a US state (e.g. Michigan) may be placed in the same shipping “zone” for a cheaper shipping charge than some interstate shipping within the US (e.g, from Michigan to California), if the actual cost of transporting goods from a shipping origin address (e.g. in Michigan) to a nearby recipient address in a foreign country (e.g. Ontario, Canada) is less than an interstate shipping cost between some states in the US.

In addition, for the purpose of describing the invention, a term “carrier” is defined as a shipping company or a transport services company, which provides transportation and delivery services of products or items from an origin address (e.g. at a store warehouse, a distribution center, and etc.) to a recipient address which may be located domestically or internationally.

Furthermore, for the purpose of describing the invention, a term “server” is defined as a physical computer, another hardware device, a software module, or a combination thereof, wherein the “server” is dedicated to executing one or more computer programs. In general, a server is connected to other devices via one or more data transmission networks such as a local area network (LAN), a wide area network (WAN), and the Internet. In a preferred embodiment of the invention, a global and local shipping charge system for an online marketplace or an auction portal is one or more computer programs executed by a CPU and a memory unit in a computer server, wherein the one or more computer programs are configured to customize and structure shipping charges by allowing an administrator of the online marketplace/auction portal to set its own geographic zone-based pricing structures, instead of merely relaying a carrier's (i.e. shipping company's) shipping price structure to a buyer.

One aspect of an embodiment of the present invention is providing a highly-customizable shipping charge system which can define and customize shipping zones and related pricing structures by an administrator of an online marketplace/auction portal or a seller's entity for more accurate shipping charge derivations than conventional shipping information offered by carriers.

Another aspect of an embodiment of the present invention is providing an integrated and dynamically-changeable shipping charge system for local, domestic, and international destinations, which can be uniquely zoned into different pricing structures as envisioned by an administrator of an online marketplace/auction portal or a seller's entity, instead of merely relaying a carrier's shipping pricing information to a buyer.

Yet another aspect of an embodiment of the present invention is providing a buyer an option to choose an appropriate shipping method with an exact and actual cost of shipping, which is defined by a seller's customized international and domestic zoning of one or more shipping origin addresses and one or more recipient addresses.

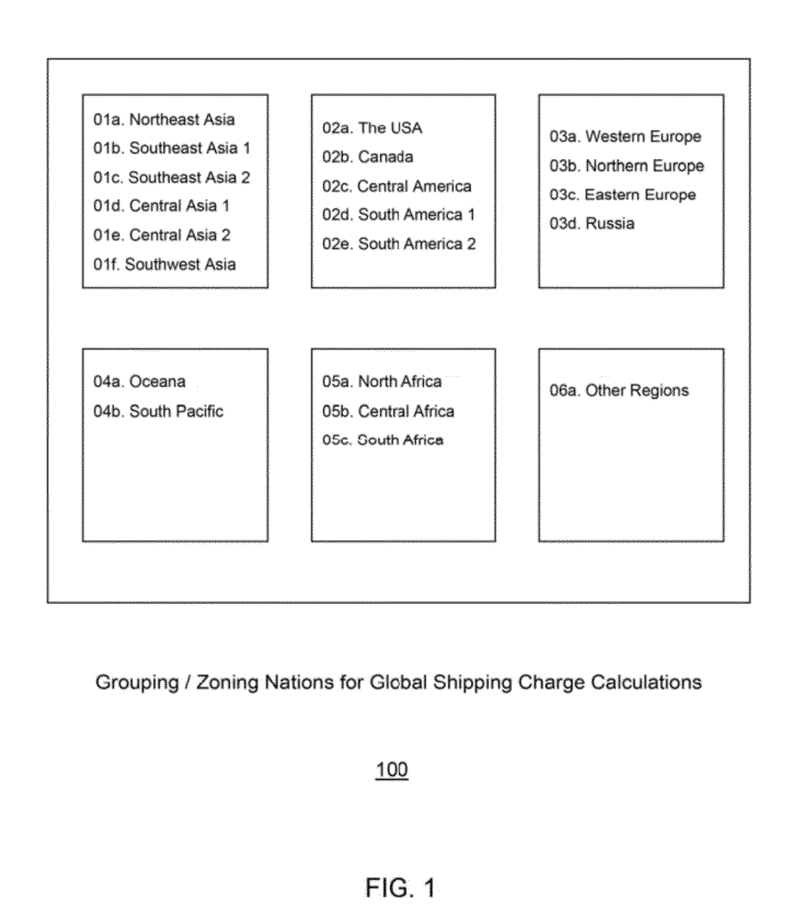

FIG. 1 shows a conceptual diagram (100) of grouping and/or zoning nations for global shipping calculations using a global and local shipping charge system, in accordance with an embodiment of the invention. In a preferred embodiment of the invention, Asia regions are categorized as 01a (Northeast Asia), 01b (Southeast Asia 1), . . . , 01f (Southwest Asia), and America regions are categorized as 02a (the USA), 02b (Canada), . . . , 02e (South America 2). Similarly, Europe regions are categorized as 03a (Western Europe), 03b (Northern Europe), 03c (Eastern Europe), 03d (Russia), and Africa regions are categorized as 05a (North Africa), 05b (Central Africa), 05c (South Africa), while some regions in the southern hemisphere are categorized as 04a (Oceana) and 04b (South Pacific). Furthermore, in the preferred embodiment of the invention, any regions in the globe not categorized by the aforementioned groups may be placed in 06a, or “Other Regions” category.

In the preferred embodiment of the invention, a computer software executed in a CPU and a memory unit of a computer system or a server enables a seller registered with an online marketplace or an administrator of the online marketplace to designate and customize shipping zones according to its particular preferences. In the example as shown in FIG. 1, the shipping zones are divided into multiple columns based on geographic proximities (e.g. Asia region, America region, Europe region, and etc.). However, in other instances, a seller or an administrator of the online marketplace may want to group nations or regions differently, depending on its own shipping charge pricing structure. For example, a seller entity which has a same flat rate deal from a carrier for the USA (02a) as a “shipping origin nation” to Russia (03d) and North Africa (05a) as “recipient nations” may want to group Russia (03d) and North Africa (05a) under the same column despite geographic differences, because they are in the same-rate zones.

In the preferred embodiment of the invention, defining and grouping a variety of different geographical regions for local, domestic, and/or international shipping destinations are contingent upon particular shipping charge policies of an online marketplace or a seller entity registered with the online marketplace. The concept of the seller-specific or the online marketplace-specific customization of shipping zones is novel and advantageous over conventional shipping charge practices in e-commerce, because the seller-specific/online marketplace-specific customization of shipping zones and rates allow more efficient and accurate shipping charge calculations than a carrier-defined shipping charge structure for different geographic regions.

In conventional e-commerce shipping charge practices, a carrier typically dictates and provides certain shipping rates to an e-commerce entity, wherein the shipping rates vary depending on shipment weight, destination addresses, and speed of delivery. In these conventional practices, a seller entity registered with an online marketplace or even an administrator to the online marketplace cannot redefine shipping rate relations to particular domestic or international recipient addresses, even if that particular seller entity or the online marketplace has a special relationship to one or more geographic regions. An example of a special relationship to one or more geographic regions is a seller entity having a multiple number of shipping origination centers around the globe. In this example, if a buyer in Singapore purchases an item offered over the Internet by a US-based seller entity which has a shipping origination center in the United States as well as Singapore, a conventional shipping calculation system offered by a carrier may not correctly take this “special relationship” of the seller entity into account in its derivation of shipping charges. The conventional shipping calculation system may only offer the US-to-Singapore international shipping rates, because a carrier-driven shipping calculation system is not designed to take the region-specific business relationships of the seller entity into account in deriving domestic or international shipping rates.

In contrast, an embodiment of the present invention for the same example can ensure that the “special relationship” of Singapore being the second shipping origination center for the seller entity is fully utilized to lower shipping charges to a buyer residing in Singapore (i.e. even if a product order is made through a US-based website) because the seller entity can redefine and customize shipping zones to take its unique and region-specific business relationship into account. Therefore, as exemplified by the aforementioned example, various embodiments of the present invention enable more efficient and logical shipping rate calculations to buyers by allowing a seller entity or an online marketplace to customize its own shipping charge structure based on its region-specific business circumstances and relationships domestically or internationally.

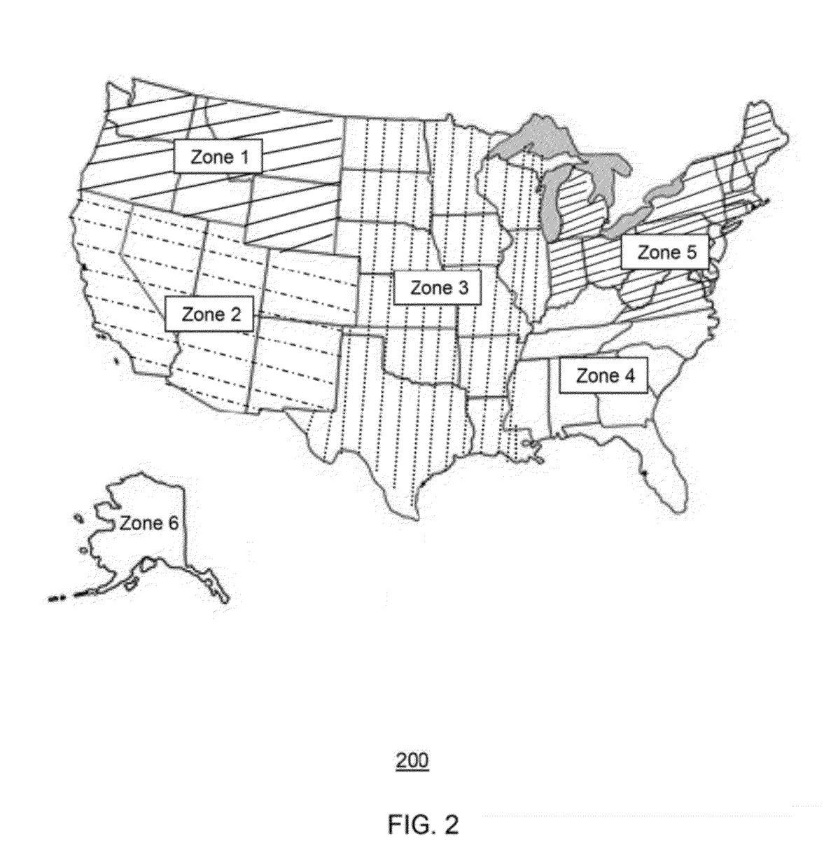

FIG. 2 shows an example of a customized geographic zoning (200) for shipping origin addresses and/or recipient addresses, which uses a global and local shipping charge system, in accordance with an embodiment of the invention. In this example, forty-eight contiguous states and the State of Alaska in the US are divided into six shipping zones. In this particular example, Zone 1 covers a northwestern portion of the United States, including Washington and Oregon. In addition, Zone 2 covers a western and southwestern portion of the United States, including California and Arizona. Furthermore, Zone 3 covers a north-central, mid-central, and south-central portion of the United States, ranging from North Dakota to Texas. Moreover, Zone 4 covers a southeastern portion of the United States, ranging from North Carolina and Kentucky to Florida, while Zone 5 covers a midwestern and northeastern portion of the United States, including Michigan, Indiana, Virginia, and New York. Lastly, Zone 6 covers Alaska in this example.

In one embodiment of the invention, a seller entity registered with an online marketplace or an administrator of the online marketplace has an access to a user interface to the global and local shipping charge system for defining and modifying shipping zones according to its region-specific business circumstances and relationships, as exemplified in descriptions associated with FIG. 1. In a preferred embodiment of the invention, the shipping zones defined and modified by the seller entity or by the administrator of the online marketplace may apply to a multiple number of carriers associated with the seller entity or the online marketplace.

For example, if the seller entity is using UPS, FedEx, and US Postal Service for domestic or international shipping, the seller entity's definition and modification of shipping zones and price structures based on its region-specific business circumstances and relationships may “redefine” conventional shipping rates offered by UPS, FedEx, and US Postal Service, based on specific circumstances of the seller entity such as location of shipping origination centers, proximity to a distribution center or a transportation hub, and other variables. In one embodiment of the invention, the “redefinition” of the seller entity's zone-based shipping rates may be a combination of carrier rates, or separate zone-based categories for each carrier. For example, if a combination of carrier rates are used in the seller entity-defined shipping zones, Zone 1 and Zone 2 shipping may be sourced to UPS, while Zone 3, 4, and 5 shipping may be sourced to FedEx. By utilizing a flexible and dynamically-changeable local and global shipping zoning and charging system for an online marketplace or a seller entity associated with the online marketplace, most economic and efficient carrier services may be hand-picked or manually-selected, zone-by-zone, according to preferences of the online marketplace or the seller entity. The enablement of zone-by-zone shipping service customization for the seller entity may also provide an additional shipping rate negotiation power to the seller entity with multiple carriers, thereby potentially reducing shipping costs for the seller entity while providing cheaper shipping charges to buyers.

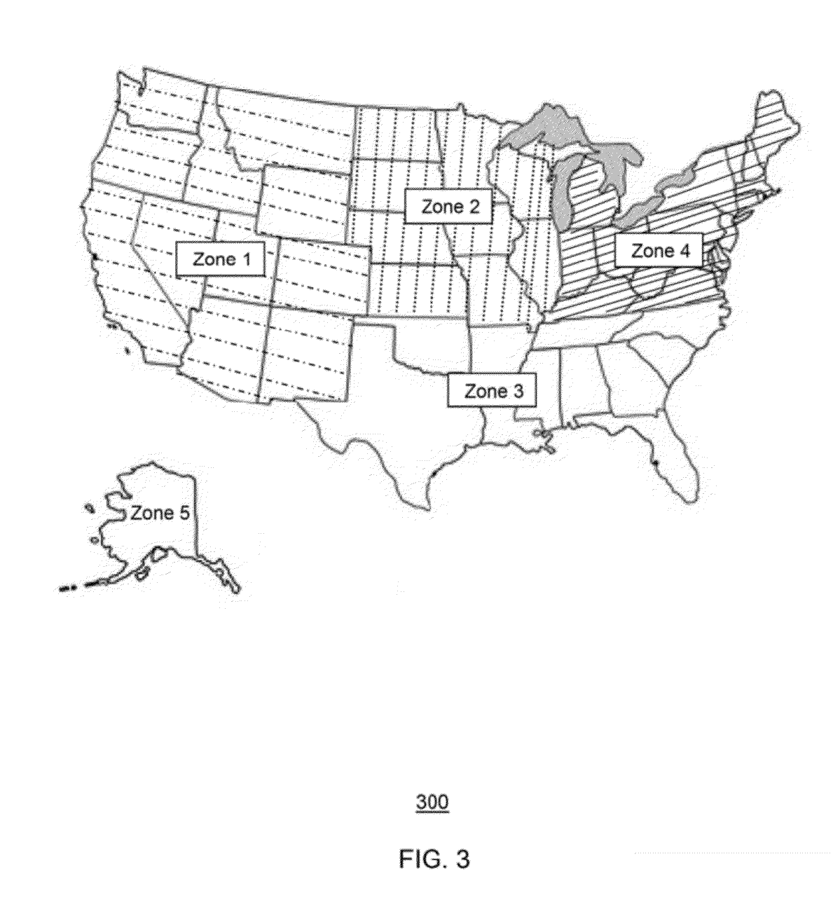

FIG. 3 shows another example of a customized geographic zoning (300) for shipping origin addresses and/or recipient addresses by using a global and local shipping charge system, in accordance with an embodiment of the invention. In this example, forty-eight contiguous states and the State of Alaska in the US are divided into five shipping zones, instead of six shipping zones as shown in the previous example in FIG. 2. In this particular example, Zone 1 in FIG. 3 covers much larger area than Zone 1 of the previous example. In particular, Zone 1 in FIG. 3 covers the northwestern portion as well as the western and the southwestern portions of the United States, as shown in FIG. 3. In addition, Zone 2 in FIG. 3 covers a smaller area (i.e. north central and central, but not south-central) than Zone 2 in FIG. 2. Furthermore, Zone 3 in FIG. 3 example covers the south-central portion as well as the southeastern portion of the United States, which is a larger zone coverage than Zone 3 in FIG. 2. Moreover, Zone 4 in FIG. 3 covers a midwestern and northeastern portion of the United States and adds the State of Kentucky as part of Zone 4, compared to Zone 4 in FIG. 2. Lastly, Zone 5 covers Alaska in this example.

In one embodiment of the invention, a seller entity registered with an online marketplace or an administrator of the online marketplace has an access to a user interface to the global and local shipping charge system for defining and modifying shipping zones according to its region-specific business circumstances and relationships, as exemplified in descriptions associated with FIG. 1. In a preferred embodiment of the invention, the shipping zones defined and modified by the seller entity or by the administrator of the online marketplace may apply to a multiple number of carriers associated with the seller entity or the online marketplace. Furthermore, the seller entity or the administrator of the online marketplace may dynamically redefine shipping zones (e.g. from a first customized shipping zoning (200) in FIG. 2 to a second customized shipping zoning (300) in FIG. 3) and related shipping charges, as carrier rates and/or region-specific business circumstances/relationships change over a period of time (e.g. a new shipping origination center, a new foreign distribution center, and etc.).

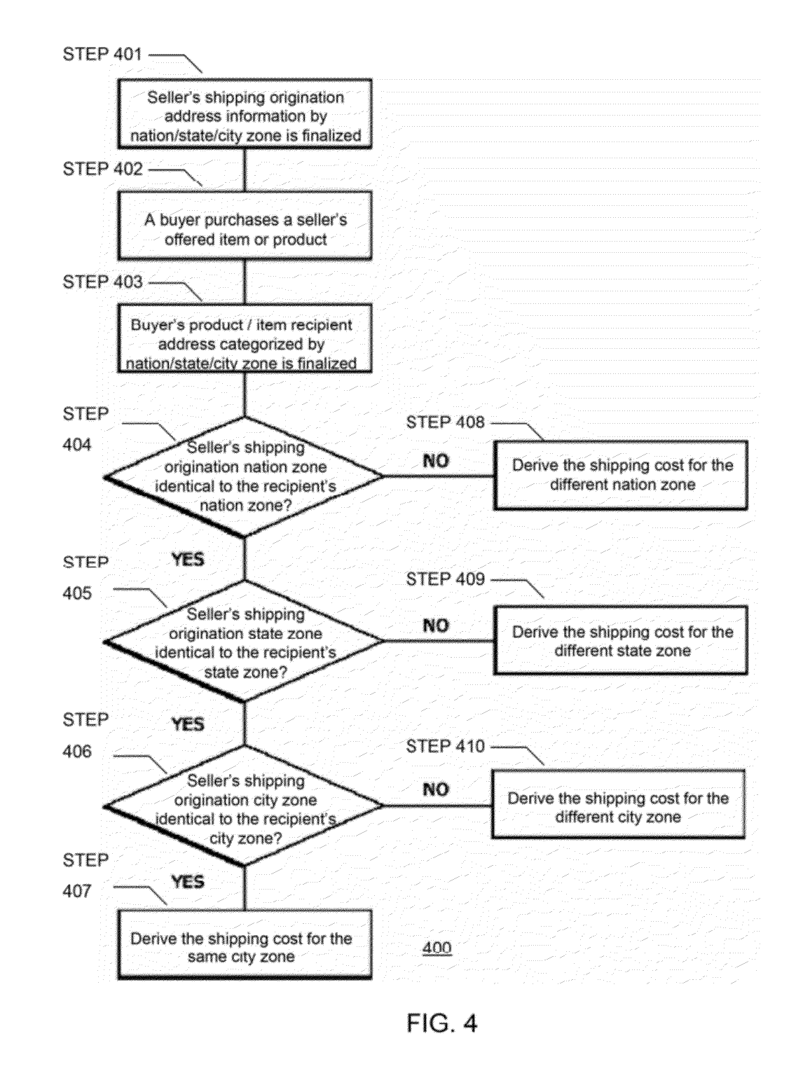

FIG. 4 shows a method (400) for deriving the shipping cost based on a customizable geographic zoning plan, in accordance with an embodiment of the invention. In a preferred embodiment of the invention, a seller entity's shipping origination address information by nation, state, and city zone is finalized and registered with the global and local shipping charge system, which may be managed by an administrator of an online marketplace or the seller entity itself, as shown in STEP 401. Then, in STEP 402, a buyer purchases an item or a product offered by the seller entity via the online marketplace or via another electronic storefront. In the preferred embodiment of the invention, the buyer also enters a product recipient address, which the global and local shipping charge system may have categorized by nation, state, and city zones, as shown in STEP 403.

If the seller entity's shipping origination “nation zone” is different from the recipient's “nation zone” (i.e. requiring an international shipping), as shown in STEP 404, then the global and local shipping charge system derives the shipping cost for the different nation zone, as shown in STEP 408. On the other hand, if the seller entity's shipping origination “nation zone” is identical to the recipient's “nation zone” (i.e. domestic shipping), then the global and local shipping charge system checks whether the seller entity's shipping origination “state zone” is identical to the recipient's “state zone,” as shown in STEP 405. If the state zones are different, then the global and local shipping charge system derives the shipping cost for the different state zone, as shown in STEP 409. On the other hand, if the seller entity's shipping origination “state zone” is identical to the recipient's “state zone” (i.e. in-state shipping), then the global and local shipping charge system further checks whether the seller entity's shipping origination “city zone” is identical to the recipient's “city zone,” as shown in STEP 406. If the city zones are different, then the global and local shipping charge system derives the shipping cost for the different city zone, as shown in STEP 410. On the other hand, if the seller entity's shipping origination “city zone” is identical to the recipient's “city zone” (i.e. same-city shipping), then the global and local shipping charge system derives the shipping cost for the same city zone, as shown in STEP 407.

Continuing with FIG. 4, in one embodiment of the invention, the shipping cost derivation may utilize multiple number of carriers or even involve a seller entity's direct delivery of goods without using a carrier such as UPS, FedEx, or US Postal Service, especially if a recipient address is in the same city zone, as shown in STEP 407. Furthermore, in one embodiment of the invention, the global and local shipping charge system can generate shipping costs by multiple carriers (e.g. UPS, FedEx, US Postal Service) and display a buyer's shipping choices and related shipping charges by each carrier per a shipping zone defined or redefined by the seller entity. In another embodiment of the invention, the global and local shipping charge system can combine only the most cost-efficient and advantageous shipping charges from multiple carriers for multiple shipping zones defined or redefined by the seller entity. Yet in another embodiment of the invention, the seller entity may manually enter shipping charges according to its preferred shipping charges at least for some shipping zones, while integrating carriers' standard shipping charges for some other shipping zones.

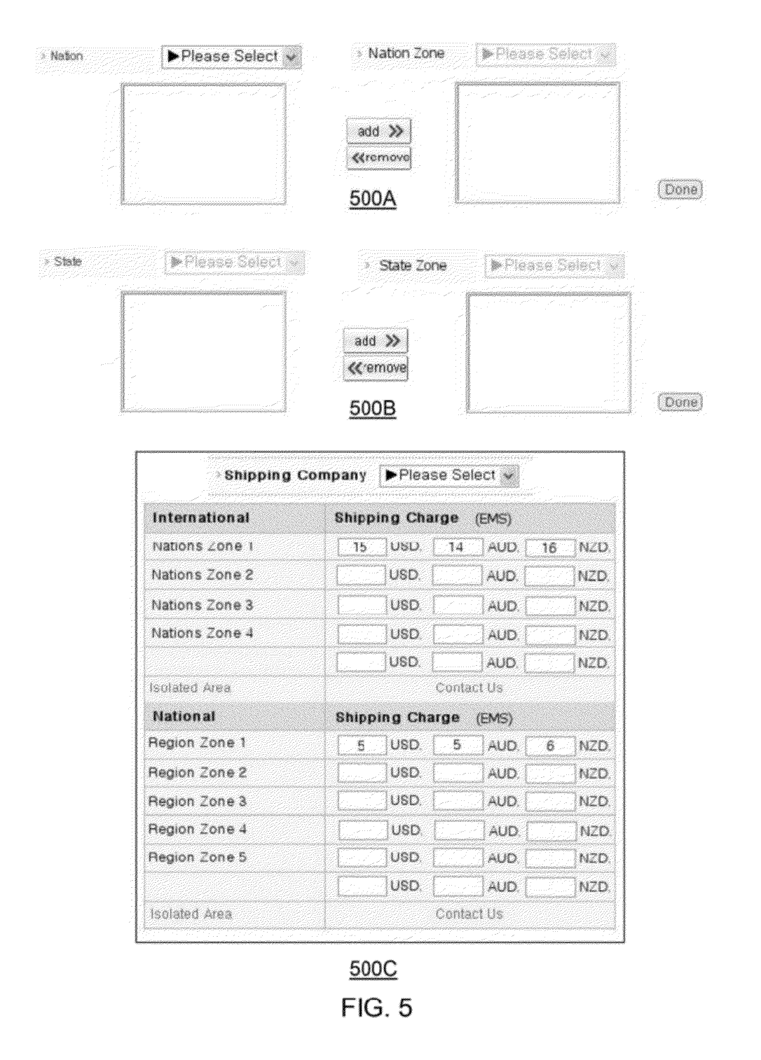

FIG. 5 shows a first pull-down menu interface for defining a nation zone (500A), a second pull-down menu interface for defining a state zone (500B), and a shipping charge plan customization interface (500C) for international “nations zones” and national “region zones” for usage by a seller entity or an online marketplace/auction portal administrator, in accordance with an embodiment of the invention.

In one embodiment of the invention, the first pull-down menu interface for defining a nation zone (500A) enables selection of a particular country (e.g. the United States) using a pull-down sub-menu on a top left-hand column, which will place that particular country's name in a bottom left-hand column. Then, if a user (e.g. a seller entity, an administrator for an online marketplace, and etc.) decides to add that particular country (e.g. the United States) to a particular “nation zone” (e.g. America region column (02a˜02e in FIG. 1)) which can be accessed by using another pull-down sub-menu on a top right-hand column, then the user can activate the “add” button to make that particular “nation zone” contain the selected country (e.g. the United States) in the list of countries in a bottom right-hand column for the particular nation zone in the first pull-down menu interface (500A). Likewise, if the user wants to remove a particular country (e.g. Peru) from a particular “nation zone” (e.g. America region column (02a˜02e in FIG. 1)) accessible by using the pull-down sub-menu on the top right-hand column, then the user can highlight that particular country (e.g. Peru) in the bottom right-hand column and activate the “remove” button to remove that particular country (e.g. Peru) from the particular nation zone.

Continuing with FIG. 5, in one embodiment of the invention, the second pull-down menu interface for defining a state zone (500B) enables selection of a particular state/province (e.g. California) using a pull-down sub-menu on a top left-hand column, which will place that particular state/province name in a bottom left-hand column. Then, if a user (e.g. a seller entity, an administrator for an online marketplace, and etc.) decides to add that particular state/province (e.g. California) to a particular “state zone,” (e.g. Zone 2 in FIG. 2) which can be accessed by using another pull-down sub-menu on a top right-hand column, then the user can activate the “add” button to make that particular “state zone” (e.g. Zone 2 in FIG. 2) contain the selected state/province (e.g. California) in the list of states/provinces in a bottom right-hand column for the particular state zone in the second pull-down menu interface (500B). Likewise, if the user wants to remove a particular state/province (e.g. South Dakota) from a particular “state zone” (e.g. Zone 3 in FIG. 2) accessible by using the pull-down sub-menu on the top right-hand column, then the user can highlight that particular state in the bottom right-hand column and activate the “remove” button to remove that particular state (e.g. South Dakota) from the particular state zone (e.g. Zone 3 in FIG. 2).

Continuing with FIG. 5, in one embodiment of the invention, the shipping charge plan customization interface (500C) for international “nations zones” and national “region zones” for usage by the seller entity or the online marketplace/auction portal administrator is generated by a computer system with a CPU and a memory unit which execute a computer program module to operate and display the shipping charge plan customization interface (500C) to a user (i.e. the seller entity or the online marketplace/.auction portal administrator). In a preferred embodiment of the invention, this computer system also executes one or more computer programs to operate the global and local shipping charge system for the seller entity or the online marketplace.

In a preferred embodiment of the invention, the seller entity or the online marketplace/auction portal administrator can either manually enter shipping charges based on its region-specific business circumstances or relationships, or operatively connect the shipping charge plan customization interface (500C) to one or more carriers' IT infrastructure to receive carrier-specific shipping charges by different geographic locations, which can be further modified on a region-by-region basis by the seller entity or the online marketplace/auction portal administrator. Furthermore, as shown by the shipping charge plan customization interface (500C) in FIG. 5, shipping charges can be customized for each carrier/shipping company with a dropdown menu, and shipping charges can be either manually or automatically adjusted to more than one currencies (e.g. US dollars, Australian dollars, New Zealand dollars, and etc.), if desired.

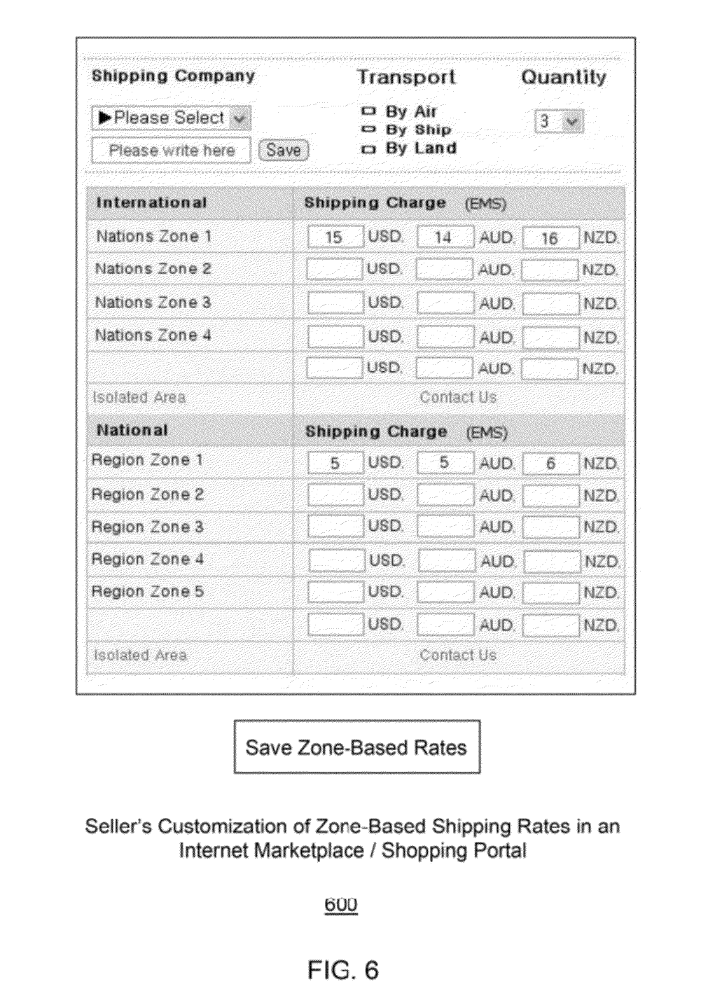

FIG. 6 shows a screenshot of a seller entity's shipping charge plan customization interface (600) for an internet marketplace/shopping portal, in accordance with an embodiment of the invention. In this embodiment of the invention, the shipping charge plan customization interface (600) for international “nations zones” and national “region zones” for usage by the seller entity or the online marketplace/auction portal administrator is generated by a computer system with a CPU and a memory unit which execute a computer program module to operate and display the shipping charge plan customization interface (600) to a user (i.e. the seller entity or the online marketplace/auction portal administrator). In a preferred embodiment of the invention, this computer system also executes one or more computer programs to operate the global and local shipping charge system for the seller entity or the online marketplace.

As shown in FIG. 6, in this embodiment of the invention, the user (i.e. the seller entity or the online marketplace/auction portal administrator) of the shipping charge plan customization interface (600) can select a particular carrier/shipping company, specify routes by land, ship, or air, and also specify bulk-pricing rates (i.e. quantity-based shipping charges) for each defined nations zone or each region zone. In a preferred embodiment of the invention, the seller entity or the online marketplace/auction portal administrator can either manually enter shipping charges based on its region-specific business circumstances or relationships, or operatively connect the shipping charge plan customization interface (600) to one or more carriers' IT infrastnicture to receive carrier-specific shipping charges by different geographic locations, which can be further modified on a region-by-region basis by the seller entity or the online marketplace/auction portal administrator. Furthermore, as shown by the shipping charge plan customization interface (600) in FIG. 6, shipping charges can be customized for each carrier/shipping company with a dropdown menu for a particular quantity (i.e. bulk pricing), and shipping charges can be either manually or automatically adjusted to more than one currencies (e.g. US dollars, Australian dollars, New Zealand dollars, and etc.), if desired. In one embodiment of the invention, once all manual, modified, and/or automated entries for shipping charges in relevant zone categories are completed, the entered information can be saved by activating “Save Zone-Based Rates” button, which stores the associated information as a zone-based customized shipping charge template.

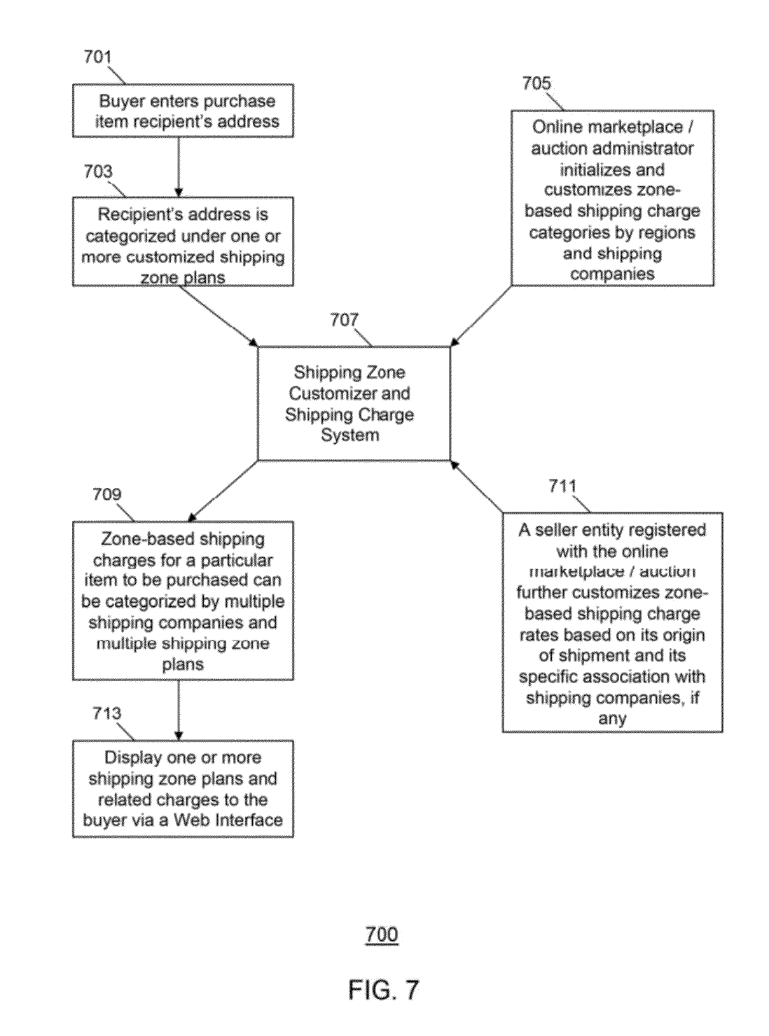

FIG. 7 shows an interaction diagram (700) among a buyer (701), an online marketplace/auction administrator (705), a seller entity (711), and a shipping zone customizer and shipping charge system (707), in accordance with an embodiment of the invention. In a preferred embodiment of the invention, an online marketplace/auction administrator initializes and customizes zone-based shipping charge categories by regions and carrier/shipping companies (705) using a shipping charge plan customization interface (e.g. 500A, 500B, 500C in FIG. 5, FIG. 1, and etc.).

Subsequently, in the preferred embodiment of the invention, a seller entity registered with the online marketplace/auction further customizes zone-based shipping charge rates based on its origin of shipment, its association with certain shipping companies, and/or its region-specific business circumstances or relationships (711), as previously shown and described for FIGS. 1-6. Furthermore, as shown in FIG. 5 and FIG. 6, the customized pricing and shipping zone information defined or redefined by the seller entity can be saved into a computer system executing one or more program modules for the global and local shipping zone customizer and shipping charge system (707).

Continuing with FIG. 7, in the preferred embodiment of the invention, the buyer (701) enters a recipient's address into a web interface or another electronic transaction interface for potential purchase of a product or an item. Then, the global and local shipping zone customizer and shipping charge system (707) categorizes the entered recipient's address under one or more customized shipping zone plans (703). Then, the shipping zone customizer and shipping charge system (707) generates one or more shipping charge prices for the purchased product/item according to the zone-based shipping charge rate defined by the seller entity based on the origin of shipment, the seller entity's association with certain carriers/shipping companies, and/or the seller entity's region-specific business circumstances or relationships (i.e. 709), which may be stored in a zone-based customized shipping charge template, as previously shown and described for FIGS. 1˜6. The one or more shipping charge prices may be categorized by carriers, speed of delivery, and/or available types of routes (i.e. land, air, sea). Then, the global and local shipping zone customizer and shipping charge system (707) can utilize a web interface on a display screen and/or another electronic medium to visualize one or more offered shipping zone plans and related shipping charges to the buyer (713).

Various embodiments of the present invention provide several key advantages to producers and retail consumers. For example, the global and local shipping zone customizer and shipping charge system as disclosed in one embodiment of the present invention enable more efficient and logical shipping rate calculations to buyers by allowing a seller entity or an online marketplace to customize its own shipping charge structure based on its region-specific business circumstances and relationships domestically or internationally. Furthermore, by providing the global and local shipping zone customizer and shipping charge system and the associated graphical user interface to the seller entity or the online marketplace to define or redefine its own shipping charge zones (i.e. independent of carriers' standard shipping rate infrastructure), various embodiments of the present invention enable more cost-efficient and flexible shipping rates for the seller entity. In particular, for international shipping policies, various embodiments of the invention can improve accuracy of shipping cost estimates at the time of a buyer's purchase request.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of generating customized shipping zones and shipping charges using a global and local shipping zone customizer and shipping charge system, the method comprising the steps of:
creating shipping zone definitions with a computer user interface for nation zones, state zones, and city zones, wherein the created shipping zone definitions are independent of a shipping company's standard shipping rates, and wherein the created shipping zone definitions are defined by a seller entity's or an online marketplace's region-specific business circumstances and region-specific relationships domestically and internationally;
placing nations, states, municipalities, and/or other points of interest into the nation zones, the state zones, the city zones, and/or other point of interest zones by using the computer user interface, wherein the computer user interface is associated with one or more program modules executed on a memory unit and a CPU of a computer system operating the global and local shipping zone customizer and shipping charge system;
associating the nation zones, the state zones, the city zones, and/or the other point of interest zones with shipping charge rates to produce a zone-based customized shipping charge template, wherein the shipping charge rates are either manually entered by the seller entity or modified from existing information;
categorizing a recipient's address entered by the buyer into a destination shipping zone characterized by at least one of the nation zones, the state zones, the city zones, and/or the other point of interest zones; and
generating a zone-based shipping charge for a particular item to be purchased by a buyer using the zone-based customized shipping charge template, the recipient's address entered by the buyer, and a shipping origination address.

2. The method of claim 1, wherein the zone-based customized shipping charge template includes multiple currencies for the shipping charge rates.

3. The method of claim 1, wherein the zone-based customized shipping charge template further includes a first menu to choose a particular shipping company and a second menu to choose transportation methods, including air, sea, and land.

4. The method of claim 1, further comprising a step of displaying the zone-based shipping charge for the particular item to be purchased by the buyer on a display screen for the buyer.

5. The method of claim 1, further comprising a step of categorizing the shipping origination address into an origination zone characterized by at least one of the nation zones, the state zones, the city zones, and/or the other point of interest zones.

6. The method of claim 5, wherein the step of generating the zone-based shipping charge for the particular item to be purchased by the buyer involves comparing the origination zone and the destination shipping zone for derivation of the zone-based shipping charge.
